(19) United States
(12) Patent Application Publication
(10) Pub. No.: US 2018/0052247 A1
(43) Pub. Date: Feb. 22, 2018

(54) FLUSH DESIGN OF AN AUTONOMOUS UNDERWATER VEHICLE WITH NEGATIVE BUOYANCY FOR MARINE SEISMIC SURVEYS

(71) Applicant: CGG SERVICES SAS, Massy Cedex (FR)

(72) Inventors: Pierrick DANIEL, Longjumeau (FR); Ivan TORRES TAMANAJA, Antony (FR); Alexandre PETRIGNY, Forges-les-Bains (FR)

(21) Appl. No.: 15/552,582

(22) PCT Filed: Dec. 8, 2015
(86) PCT No.: PCT/IB2015/002589

§ 371 Date: Aug. 22, 2017

Related U.S. Application Data
(60) Provisional application No. 62/120,902, filed on Feb. 26, 2015.

(51) Int. Cl. G01V 1/38; B63G 8/00; B63G 8/26

(52) U.S. Cl. CPC G01V 1/3852; B63G 8/001; G05D 1/0088; G01V 1/3808; B63G 8/26

(57) ABSTRACT

An autonomous underwater vehicle (AUV) for recording seismic signals during a marine seismic survey. The AUV includes a body extending along an axis X and having a front region, a middle region, and a tail region, wherein the middle region is sandwiched between the front region and the tail region along the X axis. The AUV also includes a seismic payload located within the body and configured to record seismic signals. The tail region has a trapezoidal cross-section.

### BACKGROUND

### Technical Field

Embodiments of the subject matter disclosed herein generally relate to methods and systems for collecting seismic data and, more particularly, to mechanisms and techniques for performing a marine seismic survey using autonomous underwater vehicles (AUVs) that carry appropriate seismic sensors.

### Discussion Of The Background

Seismic data processing generates a profile (image) of a geophysical structure under the seafloor based on seismic data acquired during a marine seismic survey. While this profile does not provide an accurate location of oil and gas reservoirs, it suggests, to those trained in the field, the presence or absence of these reservoirs. Thus, providing a high-resolution image of the geophysical structures under the seafloor is an ongoing process.

Reflection seismology is a method of geophysical exploration to determine the properties of earth's subsurface, which are especially helpful in the oil and gas industry. Marine reflection seismology is based on using a controlled source of energy that sends the energy into the earth. By measuring the time it takes for the reflections to come back to plural receivers, it is possible to evaluate the depth of features causing such reflections. These features may be associated with subterranean hydrocarbon deposits.

Until recently, the traditional marine seismic survey used a vessel to tow plural streamers and at least one seismic source. The seismic source is activated at given times for generating the seismic waves that carry the seismic energy into the earth. The streamers towed by the vessel include seismic sensors that record the reflected seismic waves. However, such a system is expensive, difficult to maneuver, especially around obstacles, and it is prone to have gaps in the recorded seismic data as the streamers deviate from their intended travel path due to many factors, e.g., ocean currents.

Thus, recently, the AUVs have become an important tool for replacing the streamers, as disclosed, for example, in U.S. patent application Ser. No. 13/972,139, the entire content of which is incorporated herein by reference. One challenge facing this new technology is the stability of the AUV while navigating. This problem is mainly associated to the hydrodynamic and hydrostatic forces that act and/or are created by the AUV while moving.

Accordingly, different approaches have been adopted to solve the stability problem of AUVs. However, most of the designs include at least one type of control surface (e.g., wing) externally attached to the body of the AUV and used to improve the hydrodynamic behavior. Other designs include a buoyancy chamber to control the buoyancy forces, or a directional water propulsion system to steer the AUV, or a combination of the above noted solutions. For instance, gliders use buoyancy chambers to generate vertical motion to produce horizontal displacement. In addition, the existing AUVs may use wings to produce lifting force and stability on the horizontal plane.

Nonetheless, these approaches are not well-suited for navigation close to the sea bottom since any contact with coral, rock, or any kind of sea life can damage the wings of the AUVs. As a consequence, the stability and navigation capabilities of the AUV would be compromised.

However, fulfilling the tasks associated with seismic surveying implies the use of heavy devices such as, for example, Doppler velocity logs (DVLs), side-scan sonars. The way to compensate for the weight of these devices is by adding buoyancy, thrusters or wings, which inevitably lead to an increased volume of the AUV, which is undesired.

Accordingly, it would be desirable to provide a novel AUV that offers good stability control without increasing its weight and without attaching external control surfaces to the body of the AUV.

### SUMMARY

According to one exemplary embodiment, there is an autonomous underwater vehicle for recording seismic signals during a marine seismic survey. The AUV includes a body extending along an axis X and having a front region, a middle region, and a tail region. The middle region is sandwiched between the front region and the tail region along the X axis. The AUV also includes a seismic payload located within the body and configured to record seismic signals. The tail region has a trapezoidal cross-section.

According to another embodiment, there is an AUV having a body extending along an axis X and having a front region, a middle region, and a tail region, wherein the middle region is sandwiched between the front region and the tail region along the X axis. The AUV also includes a seismic payload located within the body and configured to record seismic signals. A most distal area of the tail region from a nose of the front region forms a plane that generates a low-pressure area behind the body.

According to still another embodiment, there is a method for driving an AUV that includes activating a propulsion system of the AUV, generating a non-zero angle of attack at a front region of the AUV, creating a low-pressure area behind a tail region of the AUV by having a plane define a most distal area of the tail region, from a nose of the front region, and recording seismic data with a seismic sensor housed in a body of the AUV.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of an AUV having a tail region designed to generate a low-pressure zone behind the tail region;

FIGS. 2 and 3A are frontal views of the AUV of FIG. 1;

FIGS. 3B-D are side views of the AUV of FIG. 1;

FIG. 4 illustrates separation regions for a curved AUV;

FIG. 5 illustrates well defined separation regions for a novel AUV;

FIG. 6 is a schematic diagram of a flush AUV and the buoyancy forces and torque acting on its body;

FIG. 7 is a schematic diagram of the interior components of the AUV;

FIG. 8 is another schematic diagram of the interior components of the AUV; and

FIG. 9 is a flowchart illustrating a method for using an AUV according to an embodiment.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of an AUV having seismic sensors for recording seismic waves. However, the AUVs discussed herein may be used for other purposes than seismic data collection.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a novel AUV has a flush shape so that it has a negative buoyancy while at rest and a positive buoyancy while moving under water. The positive buoyancy is generated by the flush shape of the AUV, which is discussed next. The flush shape of the AUV combined with the specific shape of a tail region of the AUV's body generates a low-pressure zone behind the tail region. The low-pressure zone is responsible for generating a lifting force that makes the overall dynamic buoyancy of the AUV positive. The term dynamic buoyancy is understood to mean the buoyancy while the AUV moves under water, in contrast to a static buoyancy, which is understood to mean a buoyancy while the AUV is underwater at rest. The specific tail region of the AUV's body is discussed later in more detail, but it is calculated while designing the AUV's body based on the body's intended speed in water, weight, weight of the payload, and sizes. Thus, it is possible to have a first set of AUVs that have a first tail region shape for carrying a first payload and a second set of AUVs that have a different second tail region shape for carrying a second payload, which is different from the first payload.

According to an embodiment, the novel AUV has a flush shape that addresses the problem of stable underwater navigation without the use of control surfaces, as illustrated in FIGS. 1-3. This shape produces a positive overall lift when the angle of attack is greater than zero, which means that no wings or other external devices are necessary to produce positive lift. Thus, an AUV having this type of shape is capable of transporting heavy payloads while the hydrodynamic torques produced by its shape remains negligible. Moreover, due to its optimized hydrodynamic shape, this design is compact. In one example, the AUV has a size of 0.3×0.3×1.2 m and a weight of about 38 Kg. While these numbers are exemplary, they are offered to give the reader a feeling about the size of the AUV. This means that a submarine weighting about 100 tons is not considered to be AUV in this application.

FIG. 1 shows an overall view of AUV 100. AUV 100 has three regions, a front region 102, a middle region 104 and a tail region 106 that extend along a longitudinal axis X. In one application, the three regions may be formed as separate pieces and then assembled to form the body 101 of the AUV. However, in another application, the body is made as a single piece and the three regions refer to the various areas of the body. Visible in FIG. 1 are various intakes and slots, which are configured to take in water (e.g., slots 116) and to expel water (e.g., outtakes 110A-B, 114A-B). Also visible in FIG. 1 is a propeller 118 that is housed in a recess region 120 so that the exterior surface of the body is flush. The term “flush” is used in this context to mean without a control surface (as a wing) extending away from the body 101.

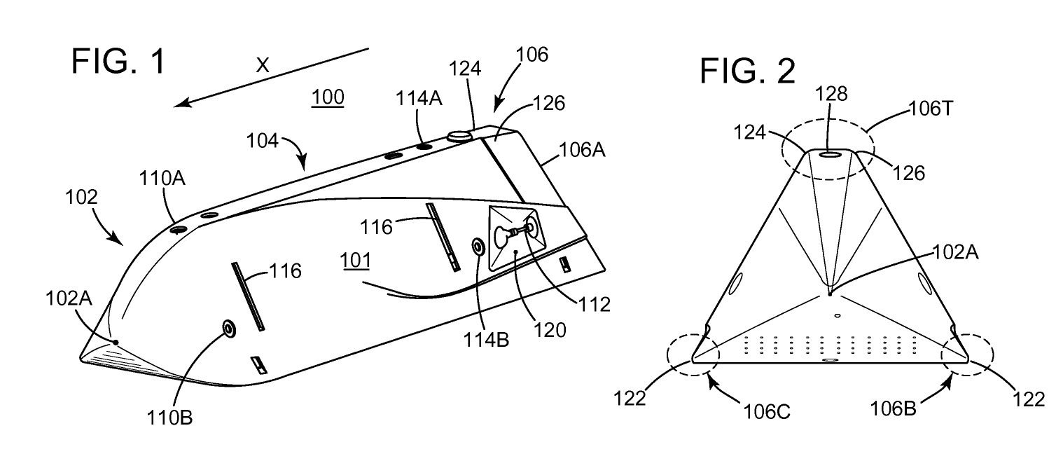

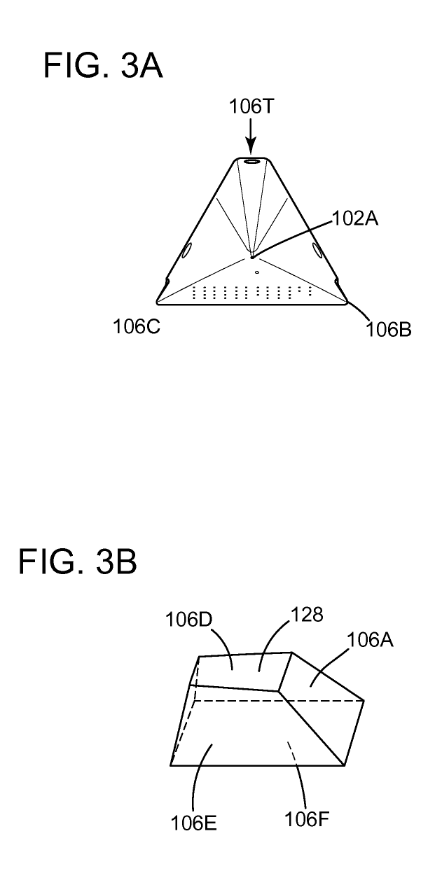

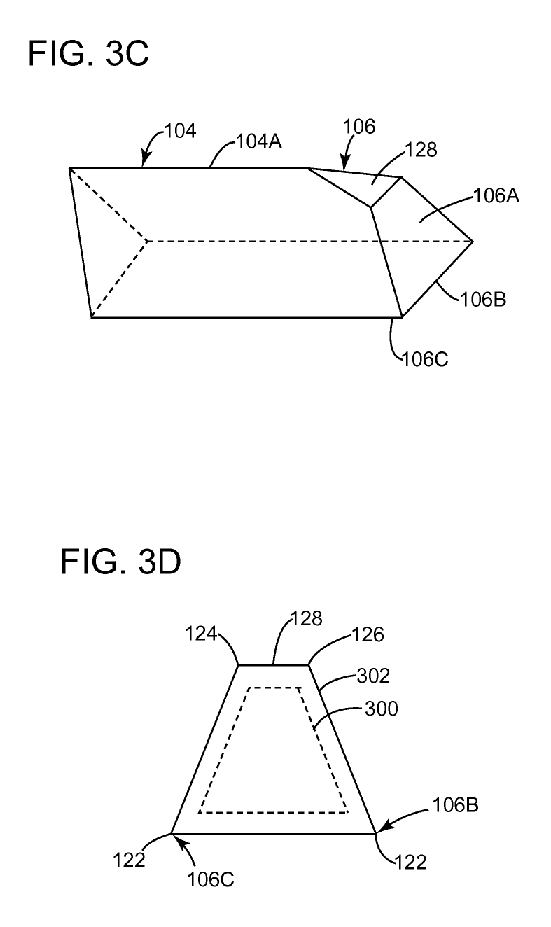

While the front region 102 is shown as being terminated in a nose 102A, the tail region 106 is terminated in a plane 106A. Plane 106A makes an angle with a horizontal line as discussed later. In another embodiment, plane 106A may be configured to change its angle by adding, for example, an actuator. By performing this modification, the angle of attack “alpha (α)” will have a wider range for navigation purposes. Plane 106A is the most distal plane from nose 102A. Nose 102A is also shown in FIG. 3A. Tail region 106 has a cross-section as illustrated in FIG. 2, i.e., a triangular-like shape having two vertices 106B-C defined by a corresponding sharp edge 122 and one vertex 106T defined by at least two straight edges 124 and 126 that sandwich a flat region 128 (note that flat region 128 is the top portion of the tail region). The three vertices 106A, B and T are also shown in FIG. 3A. A cross-section of the middle region 104 may be similar to the cross-section of the tail region. In one application, the flat region 128 for the tail region is larger than the flat region for the middle region. In still another embodiment, the middle region has a triangular cross-section while the tail region has a trapezoid cross-section, as shown in FIG. 3C. Note that FIG. 3C shows the flat region 128 for the tail region and only a sharp edge 104A for the middle region 104. In still another embodiment, the entire tail region is defined by planes, i.e., plane 106A, two lateral planes 106D-E, top flat region 128 and bottom flat region 106F as illustrated in FIG. 3B. Note that FIG. 3B shows only the tail region. In one embodiment, as illustrated in FIG. 3D, the cross-section 300 of the middle region 104 is similar but smaller than the cross-section 302 of the tail region 106.

The new design illustrated in FIGS. 1-3C generates, as discussed later, a low-pressure zone at the tail region and this zone produces a lifting force that is similar in magnitude to the lifting force created at the nose of the AUV when the AUV is navigating with an angle of attack greater than zero. As a consequence of this unexpected phenomenon, a hydrodynamic torque about pitch has a zero net value, which means equilibrium. Furthermore, the resultant of both forces yields a positive lifting force, which ensures the stability of the navigation while carrying heavy loads.

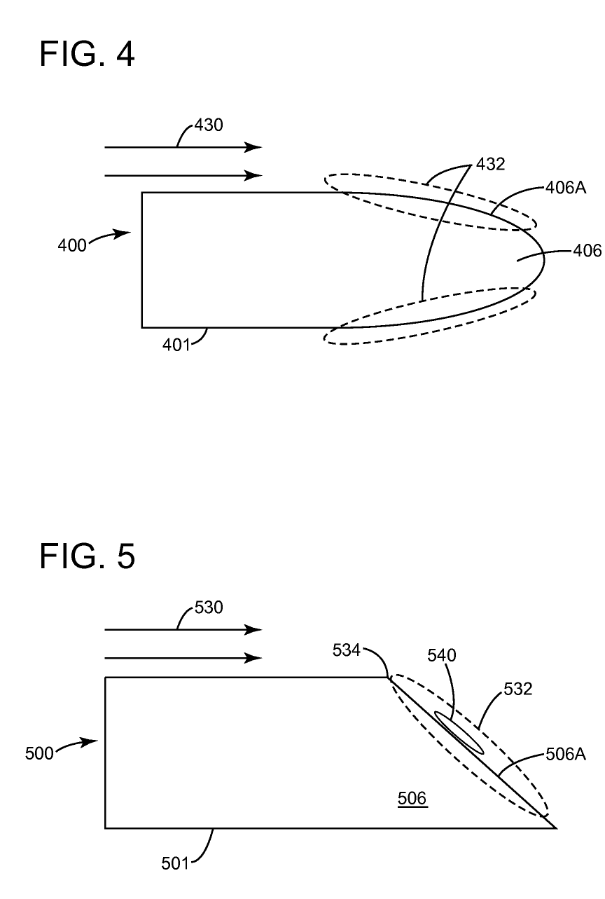

These concepts are now discussed in more detail with regard to FIGS. 4-5. Straight edges 124 and 126 in the tail region 106 are useful to control the origin of the flow separation. Note that FIGS. 1 and 2 show that the straight edges 124 and 126 may extend all the way to the front region 102. In one application, the straight edges merge at the nose 102A. In another application, the straight edges merge at the middle region, as illustrated in FIG. 3C.

The concepts of flow separation and the origin of the flow separation are now discussed. FIG. 4 shows a traditional AUV 400 having its body 401 terminated with a round tail region 406. FIG. 4 shows a side view of the AUV 400. The water flow 430 moves parallel with the body 401 until the flow reaches the tail region 406. Because the tail region 406 for the traditional AUV 400 is curved, flow separation regions 432 are formed at the tail region 406. The separation regions 432 describe those regions where the flow 430 changes its direction due to the curved shape of the tail region, or in other words, where a water of layer in contact with the skin of the AUV separates from the AUV's skin. The separation point for separation regions 432 varies in time with the speed of the AUV and other water factors, e.g., salinity, water currents, etc. At the separation point, the flow of water becomes turbulent.

Contrary to the embodiment illustrated in FIG. 4, the AUV 500 illustrated in FIG. 5 has the tail region 506 flat, described by plane 506A. This means that flow 530 departs from the body 501 at a well-defined region 532 at a well-defined point 534. If the origin of the flow separation is known a priori, the distribution of the hydrodynamic forces and moments can be selected by design. This is not the case for the traditional AUVs 400.

Comparing AUVs 400 and 500, it is noted that AUV 500's shape changes drastically at its tail, having a sloping, flat tail 506A instead of a trailing edge 406A as for the traditional AUV. Therefore, if the AUV 500 is navigating with a constant speed, the velocity of the fluid on the boundary layer will change direction and magnitude at separation regions 532. As a consequence of this action, the flow separation and a low-pressure zone 540 is produced, leading to the desired effect described above.

More specifically, most of the time, fluid separation occurs because of the frictional losses within the boundary layer (i.e., the body of the AUV). For instance, the separation in streamline bodies as illustrated in FIG. 4 occurs out of the body, i.e., on the tail zone of the body (wake creation). Because of the curved profile on the traditional AUVS, very often, it is difficult to know or estimate the flow separation point. The flush design of the AUV illustrated in FIG. 5 makes use of straight edges 124 and 126 to fix the point of separation. As a consequence, the zones of flow separation 532 can be chosen by design for the AUV 500, but not for the traditional AUV 400. Flow separation leads to low-pressure zones. Thus, by selecting the design illustrated in FIG. 5, the flow separation phenomenon produces good stability and a lifting force.

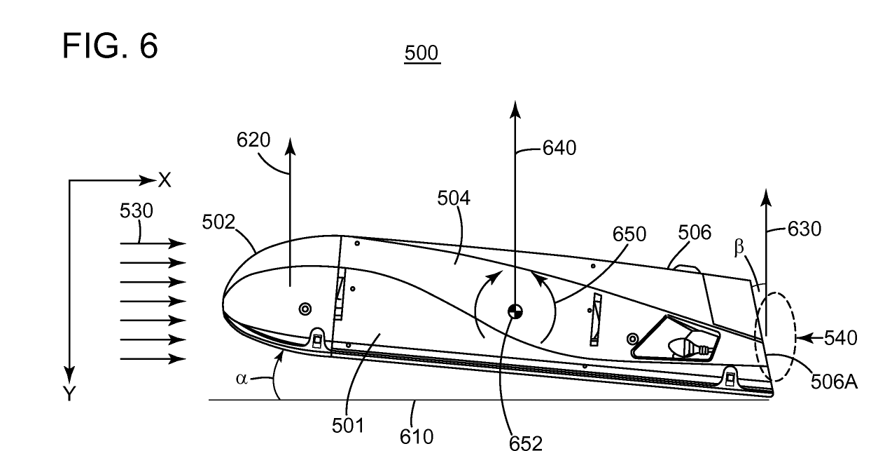

The forces that act on the AUV 500 are illustrated in FIG. 6. AUV 500 makes an angle of attach α with a horizontal line 610 and for this reason, when the flow 530 passes the body 501, a frontal hydrodynamic force 620 is produced by the front region 502. In addition, and different from the traditional AUVs, the tail region 506 generates the low-pressure zone 540, which produces a tail hydrodynamic force 630 due to the inclination of plane 506A relative to vertical Y. FIG. 6 shows plane 506A making angle β with the vertical. By changing angle β during the design, a larger or smaller force 630 is achieved. Note that both hydrodynamic forces 620 and 630 have the same orientation, i.e., opposite to gravity Y. This means that a net force 640 is exerted on the AUV 500 when moving in water, which is the equivalent to a positive buoyancy, although the AUV may have a negative static buoyancy.

In addition, because of the specific design of the tail region, the two forces 620 and 630 have similar values, which in combination with the fact that the two forces act at opposite ends of the body 501 and have the same orientation, a total (or net) torque 650 produced by forces 620 and 630 relative to a point 652, located in the middle region 504, is zero. This means that the AUV 500 has a good stability and does not rotate relative to point 652 while travelling underwater. Those skilled in the art would note that the positive buoyancy and the net zero torque is achieved because the low-pressure zone 540 can be controlled due to the design of the tail region 506 and/or due to the plane 506A. Further, the low-pressure zone is generated by having the straight edges 124 and 126 define the flat region 128, i.e., by having a trapezoid cross-section 302 for the tail region.

The AUVs shown in the previous figures have one or more of the following advantages. There is no need for a fix, movable or deployable control surface outside the body to control the attitude and altitude of the AUV; the hydrodynamic shape shown in FIGS. 1-3C facilitates the attitude and altitude while navigating with a small angle of attack; the hydrodynamic shape scales down the rocking mode of the AUV while it is lying on the sea bottom; the hydrodynamic shape allows a stable navigation of the AUV while carrying heavy loads, without the use of wings or any other prominent lifting surface (e.g., hydrofoil).

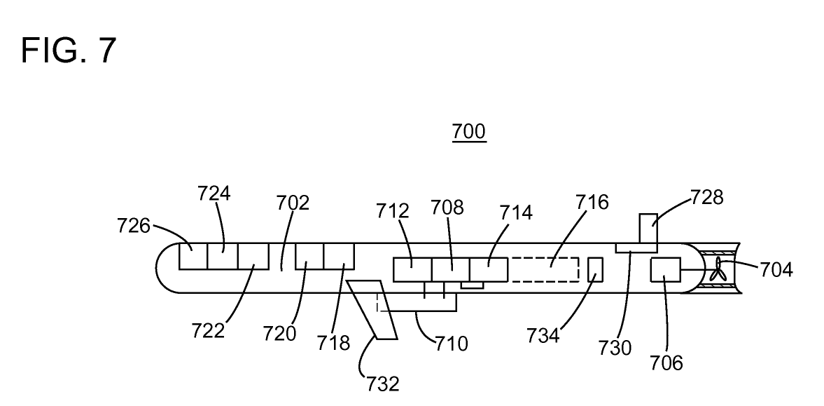

The previous embodiments have focused on the external shape of the AUV. The following figures present possible internal configurations of those AUV. FIG. 7 illustrates an AUV 700 having a body 702 to which one or more propellers 704 are attached. A motor 706 inside the body 702 activates propeller 704. Motor 706 may be controlled by a processor 708. Processor 708 may also be connected to a seismic sensor 710. Seismic sensor 710 may be shaped so that when the AUV lands on the seabed, the seismic sensor achieves a good coupling with the seabed sediments. In one embodiment, the entire seismic sensor 710 is located within the body of the AUV. The seismic sensor may include one or more of a hydrophone, geophone, accelerometer, etc. For example, if a 4C (four component) survey is desired, seismic sensor 710 includes three accelerometers and a hydrophone, i.e., a total of four sensors. Alternatively, the seismic sensor may include three geophones and a hydrophone. Of course other sensor combinations are possible.

A memory unit 712 may be connected to processor 708 and/or seismic sensor 710 for storing seismic sensor's 710 recorded data. A battery 714 may be used to power all these components. Battery 714 may be allowed to change its position along a track 716 to alter the AUV's center of gravity.

The AUV may also include an inertial navigation system (INS) 718 configured to guide the AUV to a desired location. An inertial navigation system includes at least a module containing accelerometers, gyroscopes, magnetometers or other motion-sensing devices. The INS is initially provided with the position and velocity of the AUV from another source, for example, a human operator, a GPS satellite receiver, another INS from the vessel, etc., and thereafter, the INS computes its own updated position and velocity by integrating (and optionally filtrating) information received from its motion sensors. The advantage of an INS is that it requires no external references in order to determine its position, orientation or velocity once it has been initialized.

Besides or instead of the INS 718, AUV 700 may include a compass 720 and other sensors 722 such as, for example, an altimeter for measuring its altitude, a pressure gauge, an interrogator module, etc. The AUV may optionally include an obstacle avoidance system 724 and a communication device 726 (e.g., Wi-Fi device, a device that uses an acoustic link) or other data transfer device capable of wirelessly transferring data. One or more of these elements may be linked to processor 708. The AUV further includes an antenna 728 (which may be flush with the body of the AUV) and a corresponding acoustic system 730 for communicating with the deploying, shooting or recovery vessel. The AUV may include a buoyancy system 734 for controlling the AUV's depth and keeping the AUV steady after landing.

Acoustic system 730 may be an Ultra-short baseline (USBL) system, also sometimes known as a Super Short Base Line (SSBL). This system uses a method of underwater acoustic positioning. A complete USBL system includes a transceiver, which is mounted on a pole under a vessel, and a transponder/responder on the AUV. A processor is used to calculate a position from the ranges and bearings measured by the transceiver. For example, the transceiver transmits an acoustic pulse that is detected by the subsea transponder, which replies with its own acoustic pulse. This return pulse is detected by the transceiver on the vessel. The time from transmission of the initial acoustic pulse until the reply is detected is measured by the USBL system and is converted into a range. To calculate a subsea position, the USBL calculates both a range and an angle from the transceiver to the subsea AUV. Angles are measured by the transceiver, which contains an array of transducers. The transceiver head normally contains three or more transducers separated by a baseline of, e.g., 10 cm or less.

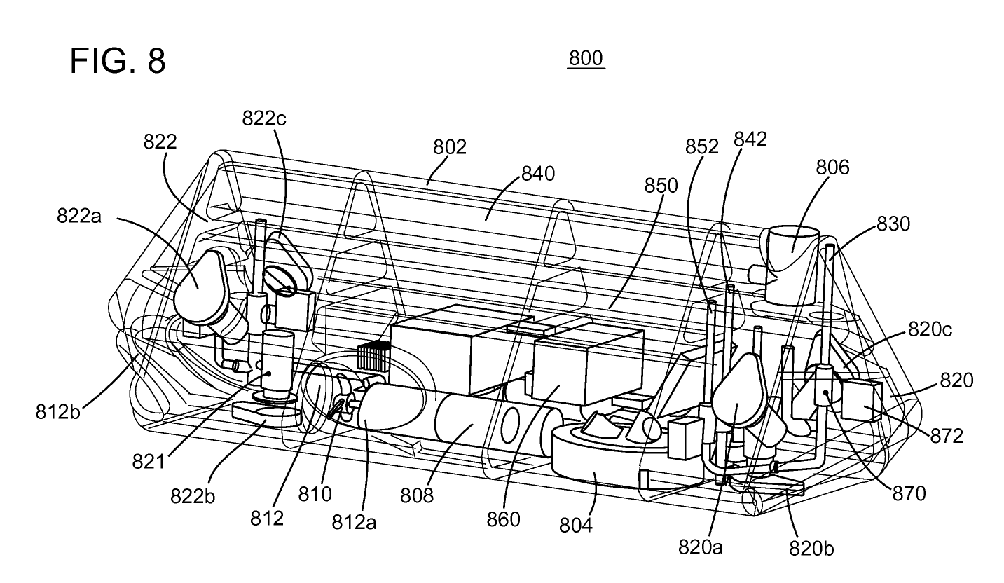

According to another embodiment illustrated in FIG. 8, an AUV 800 may include one or more chambers (three in one embodiment) that may be used to control the AUV's buoyancy. In one exemplary embodiment, the AUV has no buoyancy chamber. For example, FIG. 8 shows an AUV 800 having a body 802 with a middle portion having a triangular-like shape as discussed above with regard to FIGS. 1 to 3D. Body 802 includes a payload 804 (e.g., seismic sensors) and an acoustic transceiver 806. In one embodiment, the acoustic transceiver may partially extend outside the body 802. The acoustic transceiver 806 is configured to communicate with the vessel and receive acoustic guidance while traveling toward a desired target point. Alternatively or additionally, an INS may be used for guidance.

FIG. 8 also shows a motor 808 configured to rotate a propeller 810 for providing thrust to the AUV 800. One or more motors and corresponding propellers may be used. The entire motor 808 and propeller 810 may be within the body 802. The propeller 810 may receive water through a channel 812 in the body 802. The channel 812 has two openings, an intake water element 812a and a propulsion nozzle 812b, that communicate with the ambient water. The two openings may be located on the head, tail or middle portions of the body 802.

Guidance nozzles or turbines may be provided at the head portion 820 and/or at the tail portion 822 of the body 802. For simplicity, the guidance nozzles and the turbines are identified by the same reference numbers and are used interchangeably herein. However, if the AUV has guidance nozzles, no turbines are used and the other way around. Three guidance nozzles 820a-c may be located at the head portion 820 and three guidance nozzles 822a-c may be located at the tail portion 822 of the body 802. In one application, only the head portion nozzles are present. In still another application, only the tail portion nozzles are present. The nozzles are connected by piping to corresponding water pumps 821. If turbines are used instead of the nozzles, the element 821 is an engine that rotates a corresponding turbine. If nozzles are used, one or more water pumps may be used. These water pumps may take in water through various vents (e.g., slots 404d and/or 408e in FIG. 4A) and guide the water through one or more of the guidance nozzles (404a, 504a, 604a, 408a) at desired speeds. Alternatively, the water pumps may take in the water at one guidance nozzle and expel the water at the other nozzle or nozzles. Thus, according to this exemplary embodiment, the AUV has the capability to adjust the position of its nose with the guidance nozzles (or turbines) 820a-c and the position of its tail with the guidance nozzles (or turbines) 822a-c. However, in another embodiments, only the tail nozzles or only the nose nozzles may be implemented.

By driving water out of the body 802, according to this exemplary embodiment, the AUV has the ability to adjust the position of its head (with the guidance nozzles 820a-c) and the position of its tail (with the guidance nozzles 822a-c). However, in other embodiments, only the tail nozzles or only the head nozzles may be implemented and/or controlled. In still another exemplary embodiment, a translation of the AUV along the Y and Z axes may be controlled with the guidance nozzles. In yet another exemplary embodiment, a rotation of the AUV (yaw and pitch) may be controlled with the guidance nozzles.

FIG. 8 also shows one or more chambers 840 and 850 that communicate through piping 842 and 852 and vents 830 with the ambient water so the chambers may be flooded when desired. A control unit 860 may instruct the water pump to provide water into one or more of the chambers 840 and 850 (to partially or fully flood them) so that the AUV's buoyancy becomes neutral or negative. The same control unit 860 can instruct the water pump (or use another mechanism) to discharge water from the one or more chambers so that the AUV's buoyancy becomes positive. Alternatively, the control unit 860 instructs one or more actuators 870 to fluidly connect the vent 830 to the flooding chamber for making the AUV's buoyancy negative. For making the buoyancy positive, the control unit 860 may instruct an accumulator 872 to provide compressed gas (e.g., air, CO₂, etc.) to the flooding chambers to expel water, and then the actuator 870 seals closed the emptied flooding chambers.

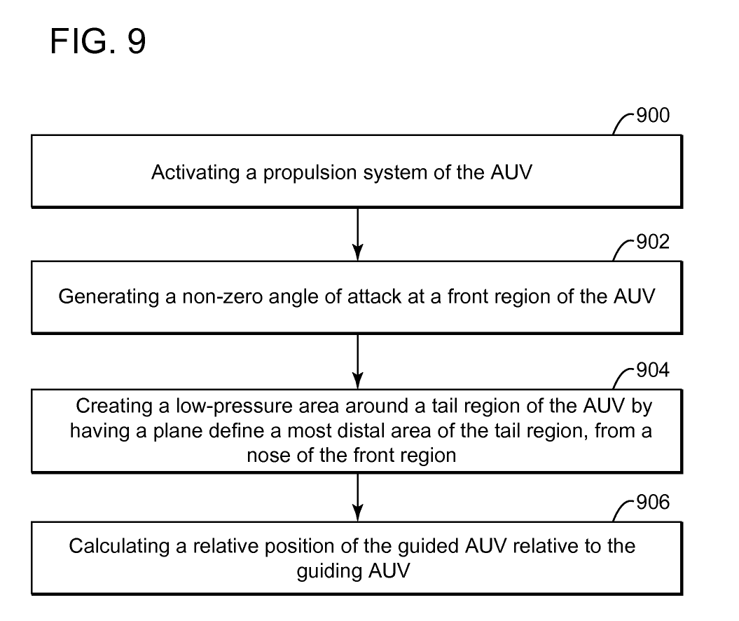

According to an embodiment illustrated in FIG. 9, there is a method for driving an AUV. The method includes a step 900 of activating a propulsion system of the AUV, a step 902 of generating a non-zero angle of attack at a front region of the AUV, a step 904 of creating a low-pressure area around a tail region of the AUV by having a plane define a most distal area of the tail region, from a nose of the front region, and a step 906 of recording seismic data with a seismic sensor housed in a body of the AUV.

One or more of the embodiments discussed above disclose an AUV configured to perform seismic recordings. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. An autonomous underwater vehicle (AUV) for recording seismic signals during a marine seismic survey, the AUV comprising:
a body extending along an axis X and having a front region, a middle region, and a tail region, wherein the middle region is sandwiched between the front region and the tail region along the X axis; and
a seismic payload located within the body and configured to record seismic signals,
wherein the tail region has a trapezoidal cross-section.

2. The AUV of claim 1, wherein the tail region includes a plane that makes a non-zero angle with a gravitational direction.

3. The AUV of claim 1, wherein the tail region includes a plane that is the most distal area from a nose of the front region.

4. The AUV of claim 1, wherein the middle region has a trapezoidal cross-section, smaller than the trapezoidal cross-section of the tail region.

5. The AUV of claim 1, wherein the body is flush so that no component of the AUV exits the body.

6. The AUV of claim 1, wherein a top surface of the tail region is flat.

7. The AUV of claim 1, wherein the entire tail region is defined by planes.

8. The AUV of claim 1, further comprising:
a propulsion system hosted by the body.

9. The AUV of claim 8, wherein, when the propulsion system is actuated, a frontal force is generated by the front region due to an angle of attack, and a tail force is generated due to a low-pressure generated by the tail region.

10. The AUV of claim 9, wherein a size of the tail region is selected so that the frontal force and the tail force create a zero net torque.

11. An autonomous underwater vehicle (AUV) for recording seismic signals during a marine seismic survey, the AUV comprising:
a body extending along an axis X and having a front region a middle region, and a tail region, wherein the middle region is sandwiched between the front region and the tail region along the X axis; and
a seismic payload located within the body and configured to record seismic signals,
wherein a most distal area of the tail region from a nose of the front region forms a plane that generates a low-pressure area behind the body.

12. The AUV of claim 11, wherein the low-pressure area generates a tail force opposite to a gravitational direction.

13. The AUV of claim 11, wherein the tail region has a trapezoidal cross-section.

14. The AUV of claim 11, wherein a front force created by a movement of the AUV in water with a non-zero angle of attack has the same direction and value as the tail force.

15. The AUV of claim 14, wherein a net torque of the frontal and the tail forces is zero for a middle point of the body.

16. A method for driving an autonomous underwater vehicle (AUV), the method comprising:
activating a propulsion system of the AUV;
generating a non-zero angle of attack at a front region of the AUV;
creating a low-pressure area behind a tail region of the AUV by having a plane define a most distal area of the tail region, from a nose of the front region; and
recording seismic data with a seismic sensor housed in a body of the AUV.

17. The method of claim 16, wherein a net force created by a non-zero angle of attack of the front region and by a low-pressure generated by the tail region is opposite to a gravitational direction.

18. The method of claim 16, wherein a net torque created a non-zero angle of attach of the front region and by a low-pressure generated by the tail region is zero.

19. The method of claim 16, wherein the tail region has a trapezoidal cross-section.

20. The method of claim 16, wherein the middle region has a trapezoidal cross-section.
